(19) United States
(12) Patent Application Publication
(10) Pub. No.: US 2004/0017482 A1
(43) Pub. Date: Jan. 29, 2004

(54) Application for a mobile digital camera, that distinguish between text-, and image-information in an image

(76) Inventor: Jacob Weitman, Djursholm (SE)

Correspondence Address: BIRCH STEWART KOLASCH & BIRCH, PO BOX 747, FALLS CHURCH, VA, 22040-0747, US

(21) Appl. No.: 10/416,841

(22) PCT Filed: Nov. 19, 2001
(86) PCT No.: PCT/SE01/02554

(30) Foreign Application Priority Data
Nov. 17, 2000 (SE) 0004231-7

(51) Int. Cl. H04N 5/225

(52) U.S. Cl. 348/207.99

(57) ABSTRACT

A digital camera is equipped with means for recognising if the information in an image is text- or image-based, or can also be used for conventional digital photographing. It is also equipped with optical character reading-means (OCR). Several methods of using such a camera are described, e.g. ordering articles and services from advertisements or catalogues; creating case records for medical care; transmitting hand-written letters and messages by mobile phone; registering and manipulating documentation from appointments and conferences; and controlling flows of packets, goods or products.

In the Swedish patent application 0002736-7 on “Method and means for mobile intelligent capture, processing, storage and transmission of text and mixed information containing characters and images”, it is shown in a broad sense how a digital camera can be used to capture and in an intelligent way interpret, store and transmit information in the form of printed or handwritten text or a combination of text and images. The interpretation implies that in a first step graphical information, such as, e.g., printed or handwritten characters, is transformed to a standard code (e.g. ASCII), but may also include more complex functions, such as translation between different languages.

The intelligence in the documentation technique thus described enables a plethora of possible applications. The present supplementary application discloses a number of applications that can become of great practical importance. Storage and use of the information captured by the camera is facilitated, if the information from the outset is tagged and given a format, such as XML, suitable for, inter alia, the Internet.

Printed information in the form of, e.g., newspapers, magazines and advertising folders is expected to remain an important communication means also in the future. The intelligent mobile camera may in this context become a versatile link between, e.g., a supplier of goods or services and a potential buyer. With the aid of the camera, and by suitably marking or by stating in handwriting in the printed advertisement, folder or catalogue the product or service requested, adding address, account number and proper authorization (such as signature), it will be possible to transmit within seconds an order to the supplier, whereby the link is preferably a mobile phone, communicating with the camera by Bluetooth or another high speed transmission technique. If the intelligent camera is equipped with a display, for instance of the LCD type, and possibly with functions for zooming, marking, correcting and supplementing, the user will be able to check, prior to transmission, that the camera has correctly interpreted, among other things, the handwritten address and any other particular instructions to the supplier.

According to the invention, the information transmitted comprises on one hand interpreted information in the form of, e.g., ASCII code, on the other hand possible image information, which also may include authorization, such as by a signature (“signature on file”). Owing to the fact that essential information is transferred in an interpreted mode, it may be used directly in the supplier's system to cause automatic dispatch or delivery of the goods or services ordered.

For the execution of the transaction thus described no new structure or manual procedure, such as specialty digital paper or processing through a scanner and computer, is required, but only the triggering of an exposure, which can cover an area corresponding to, e.g., an A4 page for each exposure. Thanks to the intelligence laid down in the camera, in combination with the method for controlling the quality of interpretation described in the previous application, the transaction can be entirely based on printed and/or handwritten text on any material. Neither is language of any importance, as the intelligence implies that the interpretation can be undertaken within one language or translated between different languages, whereby one or several languages may be laid down in the camera's basic model, whereas optional functionality and language modules can be added at a later stage. In cases when instant transmission is not possible, which may be the case during a flight where use of mobile phones is prohibited, the information is stored in the camera's buffer, to be sent as soon as the transmission channel is open.

Similar ordering services may include food from grocery stores, ready-to-eat food from restaurants, etc., where the orderer in a simple way just marks on a list or menu the type and quantity of products requested, adding address and any additional requirements and authorization, whereupon the camera transfers the interpreted information to the shop or restaurant. Even guests at a restaurant may, by marking on the menu the dishes and beverages desired and adding their table number, use the camera to transfer their order straight to the restaurant kitchen, thereby relieving the staff doing the waiting. The inventor has by this not decided upon, whether this is a particularly desirable development. The intention is merely to show the almost unlimited number of possible applications for the technique according to the invention.

The technique according to the priority and the present applications is based on a digital camera, which in important respects resembles normal digital cameras and is thus entirely different from techniques based on scanners or scanning pens with or without specialty paper. By means of a switch on the camera the intelligent functions can be bypassed, whereby the camera works as a normal digital camera for taking photos of, e.g., people and sceneries.

The referenced characteristics of the intelligent camera according to the invention allow another important application, namely documentation of information from lectures, conferences and meetings, where the lecturer or person reporting uses for his presentation, which frequently includes both writing and images, e.g. diagrams, means such as a flip chart, a black- or whiteboard or an overhead projector. According to the invention, the camera will as far as possible convert characters into ASCII code, whereas image information is processed separately. By tagging text and images and using intelligence for recognition of layout information, such as paragraphs, underlining, etc., the information captured by the camera can be transformed and when printed out reproduced as a document in, e.g., A4 format. The intelligent camera can thus be said to undertake a secretarial function in context with documentation of presentations involving written text, diagrams and images.

This secretarial function may of course also be used privately in order to, e.g., interpret, store and when desired transmit by mobile phone as e-mail or SMS notes, messages and letters, which may be written on any material.

By means of the camera manufacturers, forwarding agents, airlines and post offices can identify and document flows of goods, parcels and baggage and, at the same time, undertake control with respect to, e.g., possible damages.

Taking photos of paying-in forms allows use of the intelligent camera for highly efficient handling and ordering of payments via, e.g., mobile phones. If part of the information on the paying-in form is given as barcode, it is obviously possible to use the camera to read the barcode as well.

By means of the interpretation, tagging, control and compression techniques described in the basic patent application, only images are transmitted as graphic information, whereas all information, which has been interpreted and converted to digital code, such as ASCII code, can be handled and transmitted in a very compact way. Printed and hand written messages without images can thereby be transmitted very cost efficiently, while at the same time the user always has the option to choose between storing and transmitting of the image captured in its interpreted or in its raw form, i.e., as a conventional photo. Within the scope of the invention, manipulation of the image on, e.g., the LCD display of the camera is obviously also possible and allowed.

The unique and extremely versatile methods for capturing, interpretation, handling (including filing) and transmission of mixed text and image information, offered by the intelligent camera, makes it very well suited for keeping journals in hospitals and consulting rooms, allowing the doctor's notes to be combined and handled together with other information, such as printouts from E.C.G. units and analyzing equipment.

The intelligent mobile digital camera thus creates the necessary conditions for general and self-contained digitized document handling, comprising text, diagrams and photos in an integrated document which, as explained in the foregoing, may be linked to executive functions for, e.g., ordering of goods and services, payment of bills, instructions from a doctor to other staff in the health care sector, etc.

1. Method for application of mobile intelligent camera technique, comprising a digital camera with microprocessor, memory and software programs, preferably in combination with a mobile phone, characterized thereby that the intelligent functions of the camera are used for automatic ordering of goods or services or for controlling flows.

2. Method according to claim 1, characterized thereby that the intelligence in the camera is used such that upon taking a photo of an advertisement, a product list, a menu or some other similar commercial message or offer, the printed information is interpreted and that said interpreted information, in combination with likewise interpreted, by the user added instructions, such as indication of the goods or services requested, delivery address, account number and authorization in the form of, e.g., signature, is automatically transferred to the advertiser for handling, delivery or other comparable measures.

3. Method according to claim 1, characterized thereby that the intelligent camera is used for producing case sheets and records in the health care sector, such that general comprehensive documents are created, including the doctors interpreted hand notes, in combination with analysis results and information which can not be converted to characters and symbols, such as E.C.G. records, which are stored in the document as images, and that the documentation when required can be used in order to automatically trigger action, such as ordering examinations, printing out prescriptions and/or instructions to medical staff, etc.

4. Method according to claim 1, characterized thereby that the intelligent camera is used for ordering payments by recording, interpreting and transmission of information and instructions on invoices and paying-in forms.

5. Method according to claim 1, characterized thereby that the intelligent camera is used in order to interpret on any material written messages, letters, etc., which upon interpretation/conversion to code can be stored and/or transmitted as, e.g., e-mail or SMS.

6. Method according to claim 1, characterized thereby that the intelligent camera is used in conjunction with lectures, conferences and meetings in order to capture, interpret and transmit information on black-and whiteboards, flip charts, overhead projector screens and similar presentation facilities.

7. Method according to claim 1, characterized thereby that the intelligent camera is used for recording and controlling product, baggage and parcel flows in manufacturing industry, air transportation, mail systems and forwarding agencies, whereby the image is analyzed for its interpretable information in the form of text, symbols, and/or barcode and the information is used for identification and taking action, such as sorting, while at the same time other information in the image is deleted or stored some time tagged in such a way, that it can be recombined with the interpreted information to facilitate resolution of uncertain or complicated cases, documenting possible damages, etc.

8. Method according to claim 1, characterized thereby that the intelligent camera is used in context with traffic supervision, whereby interpretable characteristics such as registration numbers are automatically recorded and used to bring legal action against, e.g., speed limit violations.

9. Method according to any of the foregoing claims, characterized thereby that the interpreted information is suitably tagged already in the camera and is transmitted to the Internet, databases, etc., in a format, such as XML, which facilitates later handling and retrieval of the information.

10. Means for mobile intelligent digital imaging, comprising a digital camera with microprocessor, memory and software programs, preferably in combination with a mobile phone, characterized thereby that the intelligent functions can be bypassed when not required, whereby the camera works as a normal digital camera for taking photos of, e.g., people and sceneries.

11. Means according to claim 10, characterized thereby that the camera is equipped with a display of, e.g., the LCD type, which may include functions for zooming, marking, correcting and supplementing, which allow the user to check and when required correct and supplement the interpreted image information, before it is transmitted.
